(19) United States
(12) Patent Application Publication
(10) Pub. No.: US 2026/0220066 A1
(43) Pub. Date: Jul. 30, 2026

(54) FREQUENCY-DEPENDENT DATA WIDTH NEGOTIATION FOR BACKWARDS-COMPATIBLE LINKS LIKE PCI-EXPRESS AND COMPUTE EXPRESS LINK

(71) Applicant: Intel Corporation, Santa Clara, CA (US)

(72) Inventor: Debendra Das Sharma, Santa Clara, CA (US)

(21) Appl. No.: 19/578,532

(22) Filed: Mar. 25, 2026

Related U.S. Application Data
(60) Provisional application No. 63/918,937, filed on Nov. 17, 2025.

(51) Int. Cl. G06F 13/42; G06F 9/448

(52) U.S. Cl. CPC G06F 13/4221; G06F 9/4498

(57) ABSTRACT

This disclosure describes systems, methods, and devices related to optimized link negotiation. A device may negotiate a data rate with an upstream port during a configuration state of a link training and status state machine. The device may receive a capability bit from the upstream port indicating a requirement for bifurcation at the negotiated data rate. The device may activate a first logic stack and a second logic stack to serve the upstream port based on the capability bit. The device may determine a subset of physical lanes to establish a secondary link managed by the second logic stack.

### CROSS-REFERENCE TO RELATED APPLICATION(S

This application claims the benefit of U.S. Provisional Application No. 63/918,937, filed November 17, 2025, the disclosure of which is incorporated herein by reference as if set forth in full.

### BACKGROUND

Modern systems require fast and reliable ways to transfer information between different parts. Technologies have been developed to provide scalable and efficient connections for many uses. As technology advances, there is a growing need for improved methods to help these connections adapt and work better in future systems.

### BRIEF DESCRIPTION OF THE DRAWINGS

FIGS. 1-2 depict illustrative schematic diagrams for optimized link negotiation, in accordance with one or more example embodiments of the present disclosure.

FIG. 3 illustrates a flow diagram of a process for an optimized link negotiation system, in accordance with one or more example embodiments of the present disclosure.

FIG. 4 is a block diagram illustrating an example of a computing device or computing system upon which any of one or more techniques (e.g., methods) may be performed, in accordance with one or more example embodiments of the present disclosure.

FIG. 5 illustrates an embodiment of a block diagram for a computing system including a processor, in accordance with one or more example embodiments of the present disclosure.

FIG. 6 illustrates an example system, in accordance with one or more example embodiments of the present disclosure.

FIG. 7 illustrates an example system implemented as system on chip (SoC), in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

As data rate increases, sustaining the full bandwidth on the widest possible links on fully-backwards compatible links like PCI-Express (PCIe) and Compute Express Link (CXL) is becoming challenging. Let us consider a x16 PCIe Link at 256 Gigatransfers per second (GT/s) data rate (PCIe 8.0). Due to backwards compatibility, it is desired to make sure that older devices operating at a prior generation data rate (e.g., 128 GT/s for PCIe 7.0) will continue to operate at full width (e.g., x16). However, at the new data rate with that width (e.g., 256 GT/s for a x16 PCIe 8.0 device), the internal data path needs to increase 2x (since core frequencies are not scaling 2x every 2-3 years). In this context, “2x” or “x” refers to the number of parallel data paths, where “x” represents a single path and “2x” indicates a configuration using two parallel paths to increase bandwidth or processing capability.

For example, the data path needs to increase to 256B at 2G per direction for a x16 link at 256 GT/s (from 128B at 2G per direction for a x16 at 128 GT/s). Typically, header and command go in separate buses – so those need to double also. Devices need to sustain those bandwidth levels when the data access granularity is 32B for Dynamic Random-Access Memory (DRAM) access and 64B for cache line access. So that implies it is needed to access multiple cache lines/ DRAMs simultaneously every cycle, (which may be distributed over multiple locations within a die or across multiple dies or multiple sockets), while maintaining the ordering rules associated with the interface (e.g., PCI Express (PCIe) ordering rules), which may have different architectural ordering semantics of the instruction set architectures (ISAs) or internal fabric interface (e.g., Coherent Hub Interface (CHI)). Constructs like Unordered IO (UIO) help with the ordering challenges associated with enforcing simultaneous ordering across multiple accesses, but the challenges with scaling of internal data paths still exist. At this point, it is not possible to sustain these doubling of datapaths for each link.

The fundamental bottleneck in scaling these interconnects is that while the physical wire speed doubles to 256 GT/s, the internal clock frequency of the silicon remains stuck at approximately 2G due to physical manufacturing limits. To compensate for this frequency plateau, the internal datapath must grow wider to move the same amount of information, but this creates a massive congestion point where the narrow 64B cache line or 32B DRAM access must be multiplexed across a massive 256B wide internal bus. For example, if a PCIe 8.0 link is moving data at full speed, the system must juggle four separate 64B cache line requests simultaneously in a single clock cycle to keep the pipe full, which places immense pressure on the internal fabric to maintain strict PCIe ordering rules across those fragmented pieces of data.

This disclosure solves that problem by enabling parallel datapaths all the way to the internal fabric, including tapping multiple fabric attach points to deliver scalable bandwidth, and dynamic bifurcation of the link based on data rate. This disclosure addresses these scaling limitations by replacing the traditional approach of building a single, increasingly unwieldy 256B datapath with an architecture that utilizes two independent logic stacks. By bifurcating the x16 link into two x8 links specifically at the 256 GT/s rate, each stack only needs to manage a 128B datapath, which is a width that existing silicon can already handle efficiently at 2G. A practical application of this is seen when a CPU connects to a high-end GPU; rather than struggling to coordinate one massive 256B stream of data that might violate PCIe ordering during fabric congestion, the CPU communicates through two parallel x8 stacks that operate independently. This allows the system to reach the 256 GT/s bandwidth target using proven internal designs while still allowing a PCIe 7.0 device to use the full x16 width at its native 128 GT/s rate through a single stack.

Prior solutions have relied primarily on doubling the data path width, since doubling the internal clock frequency for every generation is not feasible in the logic process nodes.

Example embodiments of the present disclosure relate to systems, methods, and devices for frequency-dependent data width negotiation for backwards-compatible links like PCI-Express and compute express link.

In one or more embodiments, one or more approaches comprise the following: When the link trains, each side advertises if it can support the full native width at the highest data rate or needs to bifurcate to two stacks at the highest data rate. Have two independent stacks connecting to the same physical layer (PHY). Therefore, the stacks are doubled rather than doubling the datapath in each stack, which is more scalable. Implementations that can support a single stack for the full width and data rate, can do a partitionable design, like today’s x16 being capable of supporting two independent x8 slots (to two different devices). Two sets of configuration registers, similar to the partitioning case, except that there is a notion of primary vs secondary since both links are connecting the same two devices. One or more advantages include enabling easier and faster deployment of the higher data rates. This will help customers (as well as that of the entire ecosystem).

The mechanism for advertisement occurs during the initial handshake where both the DSP and USP exchange training sets to establish common capabilities. Instead of forcing a single logic unit to process a massive, 256B wide flow of data, this architecture allows the DSP to spin up two separate management units that share the same physical wiring but operate as distinct logical entities. This dual-stack approach is fundamentally different from standard partitioning because, while the link is physically split, the primary and secondary stacks are aware of each other and work together to serve a single endpoint.

For example, if a high-performance GPU and a CPU both support this dual-stack mode, they can operate at 256 GT/s by treating the top 8 lanes and bottom 8 lanes as separate sub-highways, each with its own set of tracking books or configuration registers. This prevents the internal hardware from becoming a bottleneck while maintaining the PCIe ordering rules required for data integrity. This scalability ensures that even if one portion of the link requires a different power state or encounters an error, the secondary registers allow the DSP to identify and manage that specific stack without necessarily crashing the entire connection.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

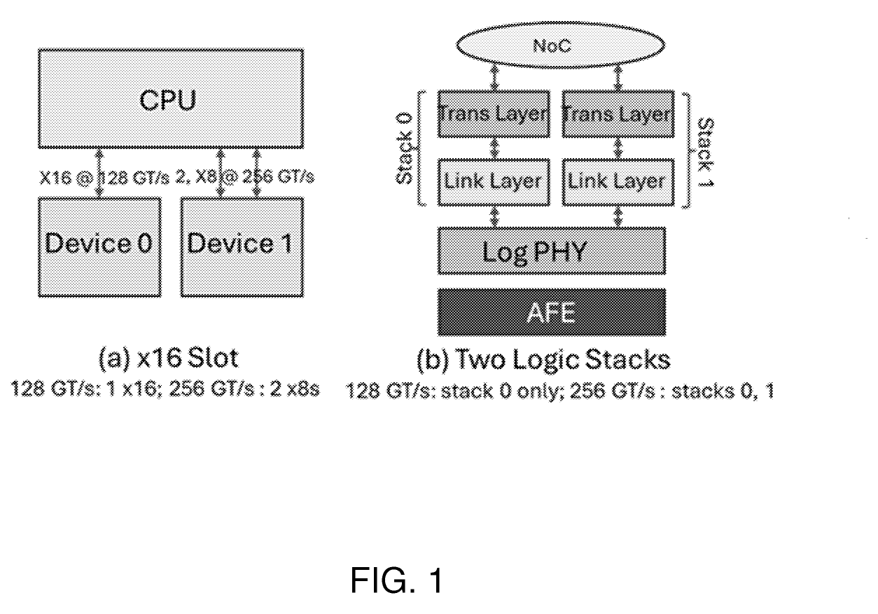

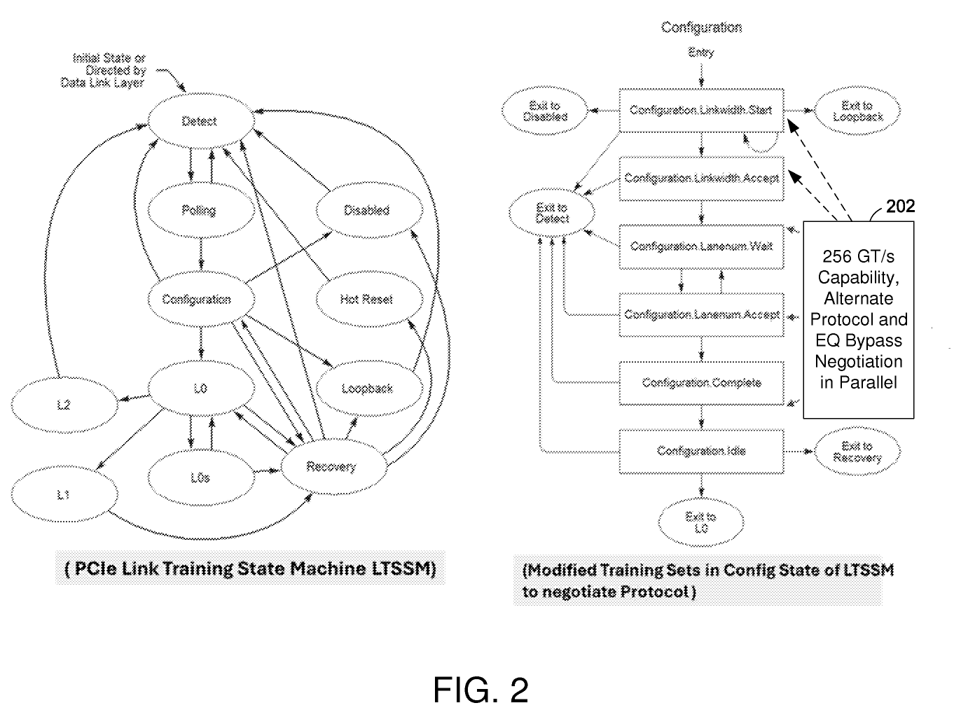

FIGS. 1-2 depict illustrative schematic diagrams for optimized link negotiation, in accordance with one or more example embodiments of the present disclosure.

The Downstream Port (DSP): Typically a CPU or Root Complex that manages link training, evaluates device capabilities, and performs the final bifurcation of the link.

The Upstream Port (USP): Typically a GPU or Endpoint device that advertises its capabilities to the DSP.

As described above, the disclosure doubles the number stacks for a x16 in PCIe Gen 8/ CXL 5.0 (basically two x16 PCIe Gen 7/CXL 4.0 stacks). Even though doubling the stacks is described for doubling the data rate in this disclosure but those skilled in the art will recognize that it can work with other set of data rate/ width increases (e.g., 3x speed increase with 3x stacks using same internal frequency, 4x speed increase can be 2x stacks with double internal frequency or 4x stacks with same internal frequency, etc.).

A x16 slot can work as a x16 link if operating at 128 GT/s (PCIe 7.0) or as 2 x8 independent links, if operating at 256 GT/s if either side cannot run natively at x16 width at 256 GT/s. Note that if both sides can run natively at x16 with 256 GT/s, they can continue as a single stack.

This has the added benefit of supporting twice the number of partitions even at the lower data rates (e.g., it is possible to connect to two different x8 devices even at 128 GT/s from the CPU). For CPUs supporting partitioning to 4x4 on a x16 Link, with this approach it is possible to support 8 x2 links on 16 Lanes. This disclosure enables full backwards compatibility with a x16 PCIe Gen 7 at identical performance levels and without any software change.

Referring to FIG. 1, there is shown a x16 Slot can be either a full x16 Link at 128 Gt/s or 2 x8 Links at 256 GT/s.

Referring to FIG. 2, there is shown link training and status state machine (LTSSM) Enhancements with PCIe/ CXL – use the Configuration.Linkwidth.Start through Configuration. Complete for bifurcation at the highest data rate/ width.

FIG. 2 illustrates the link negotiation process using a x16 capable PCIe 8.0/CXL 5.0 link as an example, though the same concept is applicable for future data rates or other interconnects. Each side advertises whether it is capable of full x16 width at 256 GT/s or can only support 2 independent x8s at 256 GT/s., while supporting a full x16 width at 128 GT/s or lower. The data rate fields in the TS1/TS2 training sets will add the 256 GT/s support from Polling State onwards. Additionally, it is proposed to use one of the reserved bits in the NFTS field (NFTS[5]) in the TS1/ TS2/ Modified TS1/TS2 training sets (with 8b/10b and 128b/130b encoding) during Configuration.Linkwidth.Start, Configuration.Linkwidth.Accept, Configuration.Lanenum.Wait, Configuration.Lanenum.Accept, and Configuration.Complete. This applies to the traditional link training starting with 2.5 GT/s rate or the bypassed to an NRZ data rate where 128b/130b encoding is used. A 0b indicates full x16 (or lower width) support at 256 GT/s and a 1b indicates a max x8 support at 256 GT/s (so 16 lanes must be split as 2 x8 when connecting two Ports).

If the 2.5 GT/s data rate is bypassed to 64 GT/s or higher data rates for optical redriver type usage, it is proposed to use the data rate encoding as follows: 1_0111b: 64 GT/s; 1_0011: 128 GT/s, 1_0001: 256 GT/s at max x8 width; 0_0001: x16 at 256 GT/s. This is the equivalent of NFTS[5] described below. Alternatively, since this is assumption-based, it is possible to assume that both sides know the capability and there is no need to distinguish between 2 x8 vs 1 x16 in the TS1/TS2 with 1b/1b encoding.

TS1 and TS2 refer to specific training sequences used during the initialization and negotiation phases of PCI Express (PCIe) and Compute Express Link (CXL) connections. These sequences, known as Training Set 1 (TS1) and Training Set 2 (TS2), are exchanged between connected devices to establish link parameters such as lane width, data rate, and supported protocols. TS1 is typically used to signal the start of link training and to communicate initial capabilities, while TS2 is employed to finalize link settings and confirm readiness for normal data transmission. Modified versions of TS1 and TS2 can include additional bits or fields to support advanced features, such as bifurcation for higher speeds or alternate protocols, ensuring that both ends of the link are synchronized and configured to operate efficiently and reliably.

It should be noted that other encodings are possible using same bits or different bits.

When the Link enters Configuration.Lanenum.Wait, the Flit Mode support is determined and the link has been established. So this is the point where the 256 GT/s capabilities are negotiated through NFTS[5] in (modified) TS1’es while Lane numbers are being negotiated. An Upstream Port (USP, e.g., a GPU card) supporting a x16 Link at 256 GT/s must support lane reversal across the 16 Lanes, as well as each of the x8 Links that the Downstream Port (DSP, e.g., a CPU) will propose. This is being done to reduce the number of back-and-forth negotiations. If any Lane is bad, the Link must operate as a x8 only in either half.

If either Port supports only 2 x8 at 256 GT/s, the Link will operate as two independent x8s. The DSP and USP will indicate that set-up in the (modified) TS2 NFTS[5] by setting the bit to 1b. At the conclusion of Configuration.Complete (on transition to Configuration.Idle), the x16 Link will bifurcate not 2 x8s. The original LTSSM will control Lanes 0-7 and will be the primary Link and the new LTSSM will take over Lanes 8-15 and will be secondary Link (and implicitly renumber the Lanes as 0-7, which will be used on the next LTSSM state where lane numbers are used). There will be two sets of configuration registers.

In one or more embodiments, it is proposed to add a register bit in capability indicating can support max x8 at 256G (e.g., Link Capabilities 2 Register Bit 27) and in the status register 1 bit indicating secondary (e.g., a new Link Status 3 Register Bit 0).

The proposed approach above works for alternate protocols running on PCIe PHY like CXL since the changes are made when the alternate protocol is negotiated and the bits are reflected in the modified TS1/TS2 training sets.

The above paragraphs highlight the advancements in link negotiation and partitioning within modern interconnect technologies. For example, the system can dynamically adjust how physical lanes are grouped and managed based on the capabilities of the connected devices. If a slot that typically operates as a single x16 link at 128 GT/s detects that either side cannot support this width at higher speeds, it can bifurcate the connection into two independent x8 links at 256 GT/s. This flexibility allows the system to maintain optimal performance even when devices have different maximum data rates or lane widths.

A practical scenario would involve a CPU acting as the DSP and a GPU as the USP. During link negotiation, if the GPU can only support up to x8 at the highest speed, the CPU can automatically split the x16 slot into two x8 links. This enables continued high-speed communication without compromising compatibility or requiring manual configuration. Additionally, the system can support more device partitions at lower speeds, such as connecting multiple x8 or x2 devices to a single x16 slot, ensuring backward compatibility and maximizing resource utilization. These features make the interconnect both adaptable and robust for future computing needs. In one or more embodiments, FIG. 2 depicts an expanded negotiation window within the Configuration state of the LTSSM to facilitate the early identification of 256 GT/s capabilities. While the negotiation of lane numbers and bifurcation requirements typically occurs during the Lanenum phases, the negotiation box 202 in FIG. 2 illustrates that these protocol exchanges can optionally extend to the Configuration.Linkwidth.Start and Configuration.Linkwidth.Accept states. This allows the DSP and USP to begin advertising support for 256 GT/s and alternate protocols, such as CXL, as soon as the initial link width determination begins. By expanding the negotiation options to include these earlier Linkwidth states, the processing circuitry can proactively determine if a x16 link must be bifurcated into two independent x8 stacks based on the highest negotiated data rate. If either port indicates a requirement for bifurcation through the NFTS[5] bit or equivalent encoding during these early stages, the DSP can prepare to renumber the physical lanes and activate primary and secondary logic stacks more efficiently. This enhanced transition path ensures that by the time the link reaching Configuration.Idle, the dual logic stacks and their respective configuration registers are fully synchronized for high-speed operation at 256 GT/s.

It should be noted that Peripheral Component Interconnect Express (PCIe) is a high-speed serial computer expansion bus standard, widely used for connecting hardware devices to a computer. Compute Express Link (CXL) is an open standard interconnect utilized for high-speed communications between the CPU and workload accelerators or memory expansion devices. The notation x16 and x8 refers to link width designations, indicating the number of physical lanes employed in a PCIe or CXL connection; for example, x16 signifies 16 lanes, while x8 denotes 8 lanes. Data transfer rates are measured in gigatransfers per second (GT/s), representing the number of billion data transfers occurring per second across a communication channel. Dynamic Random Access Memory (DRAM) is a type of volatile memory commonly used for system main memory. Unordered Input/Output (UIO) is a mechanism designed to manage ordering rules across multiple, simultaneous data accesses. The Instruction Set Architecture (ISA) defines the abstract model of a computer, specifying supported instructions, registers, and data types. The Coherent Hub Interface (CHI) is a protocol for maintaining cache coherence between different system components. The Physical Layer (PHY) is the foundational layer of the communication stack, responsible for transmitting and receiving raw data bits over a physical medium. The Central Processing Unit (CPU) is the primary processor tasked with executing instructions in a computing system, whereas the Graphics Processing Unit (GPU) is a specialized processor optimized for graphics and parallel data processing tasks. A System on Chip (SoC) is an integrated circuit that consolidates all components of a computer or electronic system into a single chip. In PCIe/CXL contexts, the Downstream Port (DSP) typically refers to the port closer to the root complex (such as the CPU side), though in other contexts DSP may indicate Digital Signal Processor. Similarly, the Upstream Port (USP) generally refers to the port nearer to the endpoint device (such as the GPU side) but may have alternative meanings in different domains.

It is understood that the above descriptions are for the purposes of illustration and are not meant to be limiting.

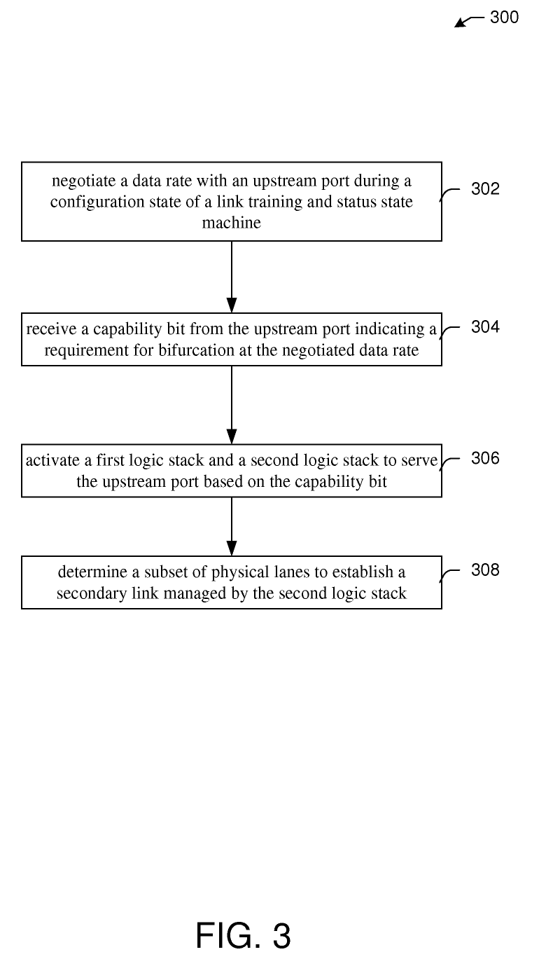

FIG. 3 illustrates a flow diagram of illustrative process 300 for an optimized link negotiation system, in accordance with one or more example embodiments of the present disclosure.

At block 302, a device may negotiate a data rate with an upstream port during a configuration state of a link training and status state machine.

At block 304, the device may receive a capability bit from the upstream port indicating a requirement for bifurcation at the negotiated data rate.

At block 306, the device may activate a first logic stack and a second logic stack to serve the upstream port based on the capability bit.

At block 308, the device may determine a subset of physical lanes to establish a secondary link managed by the second logic stack.

In one or more embodiments, a device or a system may include processing circuitry coupled to storage. The device may negotiate a data rate with an upstream port during a configuration state of a link training and status state machine. This approach addresses the challenge of establishing optimal communication speeds between connected devices, ensuring compatibility and efficient data transfer. For example, the device may select a data rate of 256 GT/s to maximize throughput while maintaining stability.

In one or more embodiments, the device may receive a capability bit from the upstream port, which may indicate a requirement for bifurcation at the negotiated data rate. This capability bit, which may be identified by locating a reserved bit in a training set field or within a modified TS1 or TS2 training set, allows the device to determine whether bifurcation is necessary for the connection. The solution provided enables dynamic adaptation to varying port requirements, thereby supporting flexible hardware configurations. For example, the device may detect the reserved bit in a modified TS1 set, triggering bifurcation logic.

In one or more embodiments, the device may activate a first logic stack and a second logic stack to serve the upstream port based on the received capability bit. The device may assign the first logic stack as the primary link and the second logic stack as the secondary link, providing a scalable solution to handle multiple data paths. This architecture solves the problem of limited bandwidth allocation by distributing traffic across two logic stacks. For example, the device may allocate the first stack to handle main data traffic and the second stack to manage overflow or specialized tasks.

In one or more embodiments, the device may determine a subset of physical lanes to establish a secondary link managed by the second logic stack. The device may renumber the subset of physical lanes by mapping physical lanes eight through fifteen as logical lanes zero through seven for the secondary link, thereby optimizing lane assignment and utilization. The device may also set a secondary link status bit in a configuration register based on the renumbering, ensuring accurate status monitoring and control. For example, the device may remap lanes to streamline secondary link initialization and set status bits for system diagnostics.

In one or more embodiments, the device may maintain a first set of configuration registers for the first logic stack and a second set of configuration registers for the second logic stack. This dual-register approach offers robust management of link states and settings, solving the problem of isolated configuration control for each logic stack. For example, the device may update the secondary stack's registers independently to adjust link parameters without impacting the primary link.

It is understood that the above descriptions are for the purposes of illustration and are not meant to be limiting.

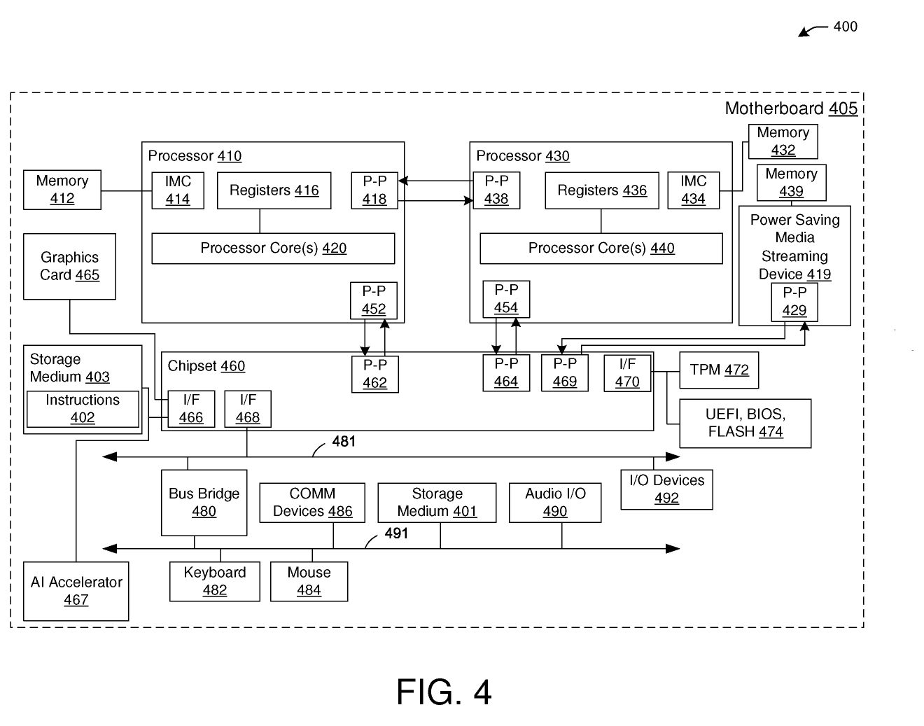

FIG. 4 illustrates an embodiment of an exemplary system 400, in accordance with one or more example embodiments of the present disclosure.

In various embodiments, the computing system 400 may comprise or be implemented as part of an electronic device.

In some embodiments, the computing system 400 may be representative, for example, of a computer system that implements one or more components of the figures in this disclosure.

The embodiments are not limited in this context. More generally, the computing system 400 is configured to implement all logic, systems, processes, logic flows, methods, equations, apparatuses, and functionality described herein.

In some embodiments, the computing system 400 may comprise or be implemented as part of an electronic device. In some embodiments, the system 400 may be representative, for example, of a computer system that implements one or more components of the figures in this disclosure. The system 400 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smartphone or other cellular phones, a telephone, a digital video camera, a digital still camera, an external storage device, or the like. Further embodiments implement larger-scale server configurations. In other embodiments, the system 400 may have a single processor with one core or more than one processor. Note that the term “processor” refers to a processor with a single core or a processor package with multiple processor cores. In addition to these configurations, system 400 may be used to process AI models, including but not limited to deep neural networks, reinforcement learning algorithms, decision trees, and ensemble learning algorithms. The system may be configured to perform large-scale AI tasks, such as model training, inference, and continuous learning, across a variety of AI frameworks and environments. The processors and the optimized link negotiation device may support hardware accelerators, such as AI chips, GPUs, or FPGAs, designed specifically to enhance the execution of AI-related computations. Furthermore, system 400 may also support edge AI processing, enabling low-latency inferencing for AI tasks in remote or constrained environments.

The computing system 400 is configured to implement all logic, systems, processes, logic flows, methods, apparatuses, and functionality described herein with reference to the above figures.

As used in this application, the terms “system,” “component,” and “module” are intended to refer to a computer-related entity, either hardware, a combination of hardware and software, software, or software in execution, examples of which are provided by the exemplary system 400. For example, a component can be, but is not limited to being, a process running on a processor, a processor, a hard disk drive, multiple storage drives (of optical and/or magnetic storage medium), an object, an executable, a thread of execution, a program, and/or a computer. In addition to these examples, the term “component” may also refer to AI models, machine learning algorithms, and AI processing engines, including supervised, unsupervised, and reinforcement learning models. Components may be deployed across various hardware resources to implement specific AI-driven functionality such as image recognition, natural language processing, predictive analytics, or decision-making processes. These components may be integrated as part of the system, either locally or distributed across multiple nodes or cloud platforms to support large-scale AI applications.

One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces. Additionally, components may exchange data in a manner tailored for AI processes, including the transfer of model weights, training data, and inference outputs. Communications between AI-specific components may involve real-time data streaming for continuous learning, neural network layer synchronization, and federated learning processes where AI models are trained across multiple distributed systems without centralizing data.

As shown in this figure, system 400 comprises a motherboard 405 for mounting platform components. The motherboard 405 is a point-to-point interconnect platform that includes a processor 410, a processor 430 coupled via point-to-point interconnects as an Ultra Path Interconnect (UPI), and an optimized link negotiation device 419. In other embodiments, the system 400 may be of another bus architecture, such as a multi-drop bus. Furthermore, each of processors 410 and 430 may be processor packages with multiple processor cores. As an example, processors 410 and 430 are shown to include processor core(s) 420 and 440, respectively. While the system 400 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 410 and the chipset 460. Some platforms may include additional components, and some platforms may only include sockets to mount the processors and/or the chipset.

The processors 410 and 430 can be any of various commercially available processors, including without limitation an Intel® Celeron®, Core®, Core (2) Duo®, Itanium®, Pentium®, Xeon®, and XScale® processors; AMD® Athlon®, Duron®, and Opteron® processors; ARM® application, embedded, and secure processors; IBM® and Motorola® DragonBall® and PowerPC® processors; IBM and Sony® Cell processors; and similar processors. Dual microprocessors, multi-core processors, and other multi-processor architectures may also be employed as the processors 410 and 430.

The processor 410 includes an integrated memory controller (IMC) 414, registers 416, and point-to-point (P-P) interfaces 418 and 452. Similarly, the processor 430 includes an IMC 434, registers 436, and P-P interfaces 438 and 454. The IMC’s 414 and 434 couple the processors 410 and 430, respectively, to respective memories, a memory 412 and a memory 432. The memories 412 and 432 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 412 and 432 locally attach to the respective processors 410 and 430.

In addition to the processors 410 and 430, the system 400 may include an optimized link negotiation device 419. The optimized link negotiation device 419 may be connected to chipset 460 by means of P-P interfaces 429 and 469. The optimized link negotiation device 419 may also be connected to a memory 439. In some embodiments, the optimized link negotiation device 419 may be connected to at least one of the processors 410 and 430. In other embodiments, the memories 412, 432, and 439 may couple with the processor 410 and 430, and the optimized link negotiation device 419 via a bus and shared memory hub. Furthermore, the optimized link negotiation device 419 may be equipped with AI processing capabilities that allow it to manage large-scale AI workloads, including the training of deep learning models and inferencing tasks. The device may also interface with AI-specific hardware, such as GPUs and TPUs, to enhance the processing power necessary for complex AI computations. Additionally, the device may handle distributed AI training tasks, enabling collaborative learning between multiple systems or nodes in a network to improve model accuracy and efficiency.

System 400 includes chipset 460 coupled to processors 410 and 430. Furthermore, chipset 460 can be coupled to storage medium 403, for example, via an interface (I/F) 466. The I/F 466 may be, for example, a Peripheral Component Interconnect- enhanced (PCI-e). The processors 410, 430, and the optimized link negotiation device 419 may access the storage medium 403 through chipset 460.

It should be noted that PCIe, UCIe, and CXL are distinct standards in computing, each serving specific functions. PCIe, or Peripheral Component Interconnect Express, is a widely adopted serial computer expansion bus standard. It’s integral for connecting high-speed components such as graphics cards, SSDs, and network cards to a motherboard, known for its scalability and efficient data transfer rates. Its point-to-point configuration reduces bottlenecks, making it highly effective. In contrast, UCIe, or Universal Chiplet Interconnect Express, is a more recent development. It standardizes the interconnect between chiplets within a single package. Chiplets are small, modular silicon blocks with specific functions, assembled to form a complex chip. UCIe’s primary aim is to streamline chiplet communication, fostering the design and creation of more efficient and powerful processors through modular integration. CXL, or Compute Express Link, focuses on high-speed, low-latency connections between CPUs and various devices like workload accelerators, memory buffers, and smart I/O devices. While leveraging the PCIe interface for its physical and electrical aspects, CXL is tailored for advanced computing tasks requiring intensive data processing, such as AI and machine learning. Its ability to efficiently share memory among various components is a key feature, marking its importance in the realm of data-intensive computing. Together, these technologies represent the diverse needs and advancements in computer hardware, from general expansion capabilities to specialized data processing and modular chip design. PCIe’s established presence contrasts with the emerging roles of UCIe and CXL, highlighting the dynamic and evolving nature of computer technology.

Storage medium 403 may comprise any non-transitory computer-readable storage medium or machine-readable storage medium, such as an optical, magnetic, or semiconductor storage medium. In various embodiments, storage medium 403 may comprise an article of manufacture. In some embodiments, storage medium 403 may store computer-executable instructions, such as computer-executable instructions 402 to implement one or more of the processes or operations described herein (e.g., process XZY00 of FIG. XZY). The storage medium 403 may store computer-executable instructions for any equations depicted above. The storage medium 403 may further store computer-executable instructions for models and/or networks described herein, such as a neural network or the like. Moreover, the storage medium 403 may also store machine learning models, pre-trained weights, datasets used for training or inference, and AI-specific processing instructions. This may include storage and retrieval mechanisms for neural networks, support vector machines, decision trees, clustering algorithms, and other AI-based architectures. The storage medium may be designed to support AI-related operations, such as model updating, hyperparameter tuning, and large-scale data processing necessary for AI applications.

The processor 410 couples to a chipset 460 via P-P interfaces 452 and 462 and the processor 430 couples to a chipset 460 via P-P interfaces 454 and 464. Direct Media Interfaces (DMIs) may couple the P-P interfaces 452 and 462 and the P-P interfaces 454 and 464, respectively. The DMI may be a high-speed interconnect that facilitates, e.g., eight Giga Transfers per second (GT/s) such as DMI 3.0. In other embodiments, the processors 410 and 430 may interconnect via a bus.

The chipset 460 may comprise a controller hub such as a platform controller hub (PCH). The chipset 460 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 460 may comprise more than one controller hub such as a chipset with a memory controller hub, a graphics controller hub, and an input/output (I/O) controller hub.

In the present embodiment, the chipset 460 couples with a trusted platform module (TPM) 472 and the UEFI, BIOS, Flash component 474 via an interface (I/F) 470. The TPM 472 is a dedicated microcontroller designed to secure hardware by integrating cryptographic keys into devices. The UEFI, BIOS, Flash component 474 may provide pre-boot code.

Furthermore, chipset 460 includes the I/F 466 to couple chipset 460 with a high-performance graphics engine, graphics card 465. In other embodiments, the system 400 may include a flexible display interface (FDI) between the processors 410 and 430 and the chipset 460. The FDI interconnects a graphics processor core in a processor with the chipset 460.

Various I/O devices 492 couple to the bus 481, along with a bus bridge 480 which couples the bus 481 to a second bus 491 and an I/F 468 that connects the bus 481 with the chipset 460. In one embodiment, the second bus 491 may be a low pin count (LPC) bus. Various devices may couple to the second bus 491 including, for example, a keyboard 482, a mouse 484, communication devices 486, a storage medium 401, and an audio I/O 490.

The AI accelerator 467 may be circuitry arranged to perform computations related to AI. The AI accelerator 467 may be connected to storage medium 403 and chipset 460. The AI accelerator 467 may deliver the processing power and energy efficiency needed to enable abundant-data computing. The AI accelerator 467 is a class of specialized hardware accelerators or computer systems designed to accelerate artificial intelligence and machine learning applications, including artificial neural networks and machine vision. The AI accelerator 467 may be applicable to algorithms for robotics, the internet of things, other data-intensive and/or sensor-driven tasks. Additionally, the AI accelerator 467 may be configured to support a variety of machine learning tasks, including but not limited to, deep learning, natural language processing, predictive analytics, computer vision, and data mining. The AI accelerator may be equipped with advanced parallel processing units designed to accelerate backpropagation, gradient descent, and other optimization algorithms integral to AI model training. Furthermore, the accelerator may support AI techniques such as transfer learning, federated learning, and reinforcement learning, enabling efficient data processing and model improvement even in data-constrained environments. The AI accelerator 467 may also support hybrid AI models, combining symbolic reasoning with neural network-based methods to enhance decision-making capabilities.

The system 400 may also be configured to manage the entire lifecycle of AI models, including model creation, training, testing, deployment, and continuous monitoring. The system may implement AI-specific optimization processes, such as hyperparameter tuning, automatic model selection, and reinforcement learning techniques, to ensure the models adapt to new data in real-time. It may also include mechanisms for explainable AI, ensuring that the models’ decision-making processes are transparent and understandable to users. Additionally, the system may support model retraining and updating, ensuring that deployed AI models remain accurate and reliable over time.

In some embodiments, the system 400 may include AI-specific data handling features, such as data preprocessing modules designed to prepare large-scale datasets for training or inference. The system may handle structured, unstructured, and semi-structured data, performing tasks such as feature extraction, dimensionality reduction, and data augmentation to improve model performance. Furthermore, the system may support real-time data analysis, allowing AI models to make decisions or predictions based on incoming data streams, enhancing the system’s ability to react to dynamic environments or rapidly changing conditions.

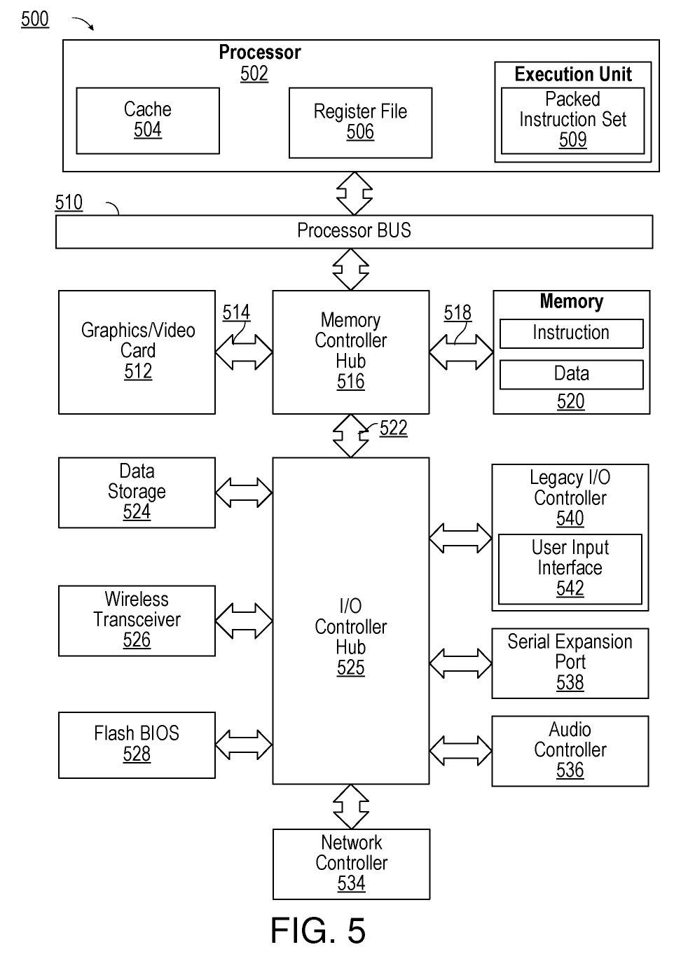

Turning to FIG. 5, a block diagram of an exemplary computer system formed with a processor that includes execution units to execute an instruction, where one or more of the interconnects implement one or more features in accordance with one embodiment of the present disclosure is illustrated. System 500 includes a component, such as a processor 502 to employ execution units including logic to perform algorithms for process data, in accordance with the present disclosure, such as in the embodiment described herein. In one embodiment, sample system 500 executes a version of an operating system and included software, and provides corresponding graphical user interfaces, may also be used. However, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 502 includes one or more execution units 508 to implement an algorithm that is to perform at least one instruction. One embodiment may be described in the context of a single processor desktop or server system, but alternative embodiments may be included in a multiprocessor system. System 500 is an example of a ‘hub’ system architecture. The computer system 500 includes a processor 502 to process data signals. The processor 502, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 502 is coupled to a processor bus 510 that transmits data signals between the processor 502 and other components in the system 500. The elements of system 500 (e.g. graphics accelerator 512, memory controller hub 516, memory 520, I/O controller hub 525, wireless transceiver 526, Flash BIOS 528, Network controller 534, Audio controller 536, Serial expansion port 538, I/O controller 540, etc.) perform their conventional functions that are well known to those familiar with the art.

In one embodiment, the processor 502 includes a Level 1 (L1) internal cache memory 504. Depending on the architecture, the processor 502 may have a single internal cache or multiple levels of internal caches. Other embodiments include a combination of both internal and external caches depending on the particular implementation and needs. Register file 506 is to store different types of data in various registers including integer registers, floating point registers, vector registers, banked registers, shadow registers, checkpoint registers, status registers, and instruction pointer register.

Execution unit 508, including logic to perform integer and floating point operations, also resides in the processor 502. The processor 502, in one embodiment, includes a microcode (ucode) ROM to store microcode, which when executed, is to perform algorithms for certain macroinstructions or handle complex scenarios. Here, microcode is potentially updateable to handle logic bugs/fixes for processor 502. For one embodiment, execution unit 508 includes logic to handle a packed instruction set 509. By including the packed instruction set 509 in the instruction set of a general-purpose processor 502, along with associated circuitry to execute the instructions, the operations used by many multimedia applications may be performed using packed data in a general-purpose processor 502. Thus, many multimedia applications are accelerated and executed more efficiently by using the full width of a processor’s data bus for performing operations on packed data. This potentially eliminates the need to transfer smaller units of data across the processor’s data bus to perform one or more operations, one data element at a time.

Alternate embodiments of an execution unit 508 may also be used in micro controllers, embedded processors, graphics devices, DSPs, and other types of logic circuits. System 500 includes a memory 520. Memory 520 includes a dynamic random access memory (DRAM) device, a static random access memory (SRAM) device, flash memory device, or other memory device. Memory 520 stores instructions and/or data represented by data signals that are to be executed by the processor 502.

Note that any of the aforementioned features or aspects of the present disclosure and solutions may be utilized on one or more interconnect illustrated in FIG. 5. For example, an on-die interconnect (ODI), which is not shown, for coupling internal units of processor 502 implements one or more aspects of the embodiments described above. Or the embodiments may be associated with a processor bus 510 (e.g. other known high performance computing interconnect), a high bandwidth memory path 518 to memory 520, a point-to-point link to graphics accelerator 512 (e.g. a Peripheral Component Interconnect express (PCIe) compliant fabric), a controller hub interconnect 522, an I/O or other interconnect (e.g. USB, PCI, PCIe) for coupling the other illustrated components. Some examples of such components include the audio controller 536, firmware hub (flash BIOS) 528, wireless transceiver 526, data storage 524, legacy I/O controller 540 containing user input and keyboard interfaces 542, a serial expansion port 538 such as Universal Serial Bus (USB), and a network controller 534. The data storage device 524 can comprise a hard disk drive, a floppy disk drive, a CD-ROM device, a flash memory device, or other mass storage device.

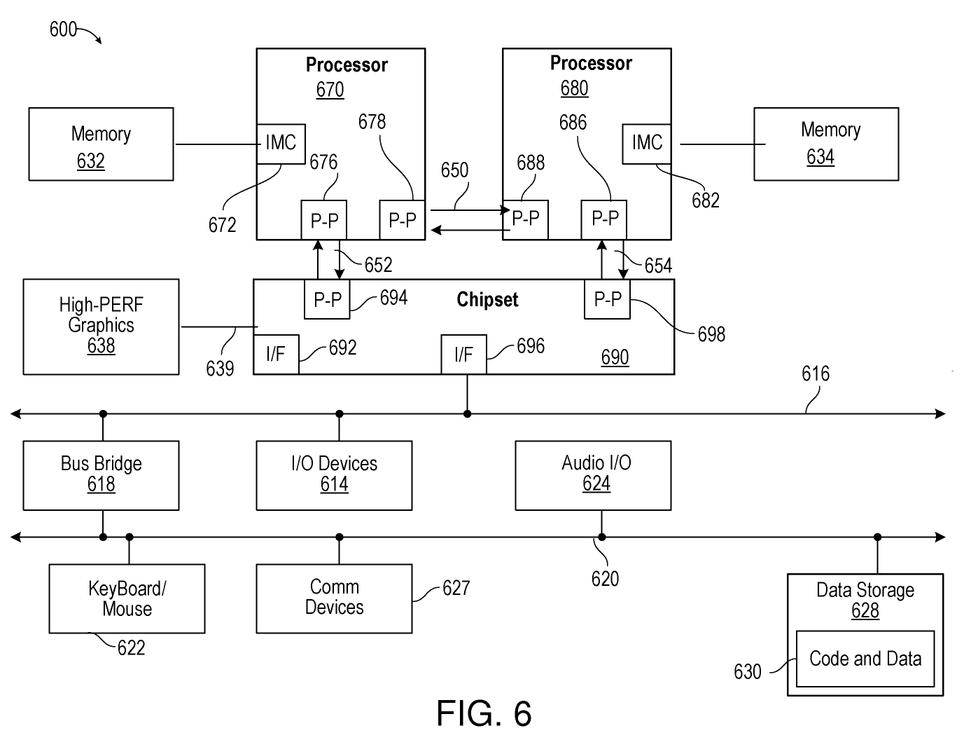

Referring now to FIG. 6, shown is a block diagram of a second system 600 in accordance with an embodiment of the present disclosure. As shown in FIG. 6 , multiprocessor system 600 is a point-to-point interconnect system, and includes a first processor 670 and a second processor 680 coupled via a point-to-point interconnect 650. Each of processors 670 and 680 may be some version of a processor. In one embodiment, 652 and 654 are part of a serial, point-to-point coherent interconnect fabric, such as a high-performance architecture.

While shown with only two processors, 670, 680, it is to be understood that the scope of the present disclosure is not so limited. In other embodiments, one or more additional processors may be present in a given processor.

Processors 670 and 680 are shown including integrated memory controller units 672 and 682, respectively. Processor 670 also includes as part of its bus controller units point-to-point (P-P) interfaces 676 and 678; similarly, second processor 680 includes P-P interfaces 686 and 688. Processors 670, 680 may exchange information via a point-to-point (P-P) interface 650 using P-P interface circuits 678, 688. As shown in FIG. 6, IMCs 672 and 682 couple the processors to respective memories, namely a memory 632 and a memory 634, which may be portions of main memory locally attached to the respective processors.

Processors 670, 680 each exchange information with a chipset 690 via individual P-P interfaces 652, 654 using point to point interface circuits 676, 694, 686, 698. Chipset 690 also exchanges information with a high-performance graphics circuit 638 via an interface circuit 692 along a high-performance graphics interconnect 639.

A shared cache (not shown) may be included in either processor or outside of both processors; yet connected with the processors via P-P interconnect, such that either or both processors’ local cache information may be stored in the shared cache if a processor is placed into a low power mode.

Chipset 690 may be coupled to a first bus 616 via an interface 696. In one embodiment, first bus 616 may be a Peripheral Component Interconnect (PCI) bus, or a bus such as a PCI Express bus or another third generation I/O interconnect bus, although the scope of the present disclosure is not so limited.

As shown in FIG. 6, various I/O devices 614 are coupled to first bus 616, along with a bus bridge 618 which couples first bus 616 to a second bus 620. In one embodiment, second bus 620 includes a low pin count (LPC) bus. Various devices are coupled to second bus 620 including, for example, a keyboard and/or mouse 622, communication devices 627 and a storage unit 628 such as a disk drive or other mass storage device which often includes instructions/code and data 630, in one embodiment. Further, an audio I/O 624 is shown coupled to second bus 620. Note that other architectures are possible, where the included components and interconnect architectures vary. For example, instead of the point-to-point architecture of FIG. 6 , a system may implement a multi-drop bus or other such architecture.

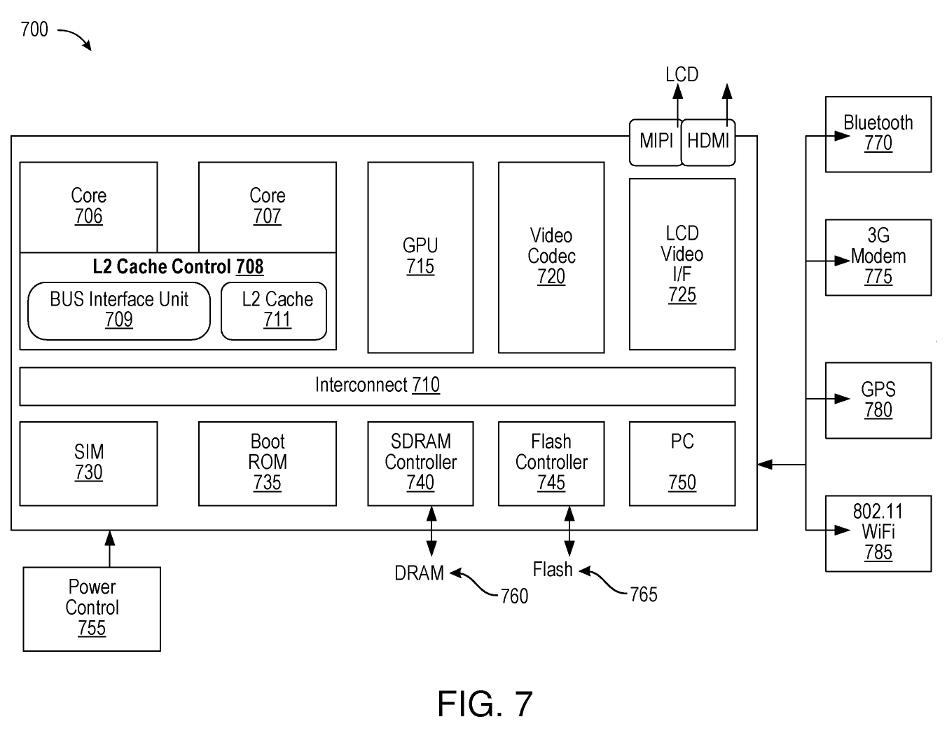

Turning next to FIG. 7, an embodiment of a system on-chip (SOC) design in accordance with the above disclosure is depicted. As a specific illustrative example, SOC 700 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 700 includes 2 cores—706 and 707. Similar to the discussion above, cores 706 and 707 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 706 and 707 are coupled to cache control 708 that is associated with bus interface unit 709 and L2 cache 711 to communicate with other parts of system 700. Interconnect 710 includes an on-chip interconnect, such as an IOSF, AMBA, or other interconnect discussed above, which potentially implements one or more aspects described herein.

Interconnect 710 provides communication channels to the other components, such as a Subscriber Identity Module (SIM) 730 to interface with a SIM card, a boot ROM 735 to hold boot code for execution by cores 706 and 707 to initialize and boot SOC 700, a SDRAM controller 740 to interface with external memory (e.g. DRAM 760), a flash controller 745 to interface with non-volatile memory (e.g. Flash 765), a peripheral control 750 (e.g. Serial Peripheral Interface) to interface with peripherals, video codecs 720 and Video interface 725 to display and receive input (e.g. touch enabled input), GPU 715 to perform graphics related computations, etc. Any of these interfaces may incorporate aspects of the embodiments described herein.

In addition, the system illustrates peripherals for communication, such as a Bluetooth module 770, 3G modem 775, GPS 780, and WiFi 785. Note as stated above, a UE includes a radio for communication. As a result, these peripheral communication modules are not all required. However, in the UE some form of radio for external communication is to be included.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expressions “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The following examples pertain to further embodiments.

Example 1 may include a device comprising processing circuitry coupled to storage, the processing circuitry configured to: negotiate a data rate with an upstream port during a configuration state of a link training and status state machine; receive a capability bit from the upstream port indicating a requirement for bifurcation at the negotiated data rate; activate a first logic stack and a second logic stack to serve the upstream port based on the capability bit; and determine a subset of physical lanes to establish a secondary link managed by the second logic stack.

Example 2 may include the device of example 1 and/or some other example(s) herein, wherein the processing circuitry may be further configured to receive the capability bit by identifying a reserved bit in a training set field.

Example 3 may include the device of example 1 and/or some other example(s) herein, wherein the capability bit may be received within a modified TS1 or TS2 training set.

Example 4 may include the device of example 1 and/or some other example(s) herein, wherein the processing circuitry may be further configured to assign the first logic stack as a primary link and the second logic stack as the secondary link.

Example 5 may include the device of example 1 and/or some other example(s) herein, wherein the processing circuitry may be further configured to cause to renumber the subset of physical lanes by mapping physical lanes 8 through 15 as logical lanes 0 through 7 for the secondary link.

Example 6 may include the device of example 1 and/or some other example(s) herein, wherein the processing circuitry may be further configured to set a secondary link status bit in a configuration register based on the renumbering.

Example 7 may include the device of example 1 and/or some other example(s) herein, wherein the negotiated data rate may be 256 Gigatransfers per second (GT/s).

Example 8 may include the device of example 1 and/or some other example(s) herein, wherein the processing circuitry may be further configured to maintain a first set of configuration registers for the first logic stack and a second set of configuration registers for the second logic stack.

Example 9 may include the device of example 1 and/or some other example(s) herein, wherein the first logic stack and the second logic stack connect to a single shared physical layer.

Example 10 may include a non-transitory computer-readable medium storing computer-executable instructions which when executed by one or more processors result in performing operations comprising: negotiating a data rate with an upstream port during a configuration state of a link training and status state machine; receiving a capability bit from the upstream port indicating a requirement for bifurcation at the negotiated data rate; activating a first logic stack and a second logic stack to serve the upstream port based on the capability bit; and determining a subset of physical lanes to establish a secondary link managed by the second logic stack.

Example 11 may include the non-transitory computer-readable medium of example 10 and/or some other example(s) herein, wherein the operations further comprise receiving the capability bit by identifying a reserved bit in a training set field.

Example 12 may include the non-transitory computer-readable medium of example 10 and/or some other example(s) herein, wherein the capability bit may be received within a modified TS1 or TS2 training set.

Example 13 may include the non-transitory computer-readable medium of example 10 and/or some other example(s) herein, wherein the operations further comprise assigning the first logic stack as a primary link and the second logic stack as the secondary link.

Example 14 may include the non-transitory computer-readable medium of example 10 and/or some other example(s) herein, wherein the operations further comprise causing to renumber the subset of physical lanes by mapping physical lanes 8 through 15 as logical lanes 0 through 7 for the secondary link.

Example 15 may include the non-transitory computer-readable medium of example 10 and/or some other example(s) herein, wherein the operations further comprise setting a secondary link status bit in a configuration register based on the renumbering.

Example 16 may include the non-transitory computer-readable medium of example 10 and/or some other example(s) herein, wherein the negotiated data rate may be 256 Gigatransfers per second (GT/s).

Example 17 may include the non-transitory computer-readable medium of example 10 and/or some other example(s) herein, wherein the operations further comprise maintaining a first set of configuration registers for the first logic stack and a second set of configuration registers for the second logic stack.

Example 18 may include the non-transitory computer-readable medium of example 10 and/or some other example(s) herein, wherein the first logic stack and the second logic stack connect to a single shared physical layer.

Example 19 may include a method comprising: negotiating a data rate with an upstream port during a configuration state of a link training and status state machine; receiving a capability bit from the upstream port indicating a requirement for bifurcation at the negotiated data rate; activating a first logic stack and a second logic stack to serve the upstream port based on the capability bit; and determining a subset of physical lanes to establish a secondary link managed by the second logic stack.

Example 20 may include the method of example 19 and/or some other example(s) herein, the method further comprising receiving the capability bit by identifying a reserved bit in a training set field.

Example 21 may include the method of example 19 and/or some other example(s) herein, wherein the capability bit may be received within a modified TS1 or TS2 training set.

Example 22 may include the method of example 19 and/or some other example(s) herein, the method further comprising assigning the first logic stack as a primary link and the second logic stack as the secondary link.

Example 23 may include the method of example 19 and/or some other example(s) herein, the method further comprising causing to renumber the subset of physical lanes by mapping physical lanes 8 through 15 as logical lanes 0 through 7 for the secondary link.

Example 24 may include the method of example 19 and/or some other example(s) herein, the method further comprising setting a secondary link status bit in a configuration register based on the renumbering.

Example 25 may include the method of example 19 and/or some other example(s) herein, wherein the negotiated data rate may be 256 Gigatransfers per second (GT/s).

Example 26 may include the method of example 19 and/or some other example(s) herein, the method further comprising maintaining a first set of configuration registers for the first logic stack and a second set of configuration registers for the second logic stack.

Example 27 may include the method of example 19 and/or some other example(s) herein, wherein the first logic stack and the second logic stack connect to a single shared physical layer.

Example 28 may include an apparatus comprising means for: negotiating a data rate with an upstream port during a configuration state of a link training and status state machine; receiving a capability bit from the upstream port indicating a requirement for bifurcation at the negotiated data rate; activating a first logic stack and a second logic stack to serve the upstream port based on the capability bit; and determining a subset of physical lanes to establish a secondary link managed by the second logic stack.

Example 29 may include the apparatus of example 28 and/or some other example(s) herein, further comprising receiving the capability bit by identifying a reserved bit in a training set field.

Example 30 may include the apparatus of example 28 and/or some other example(s) herein, wherein the capability bit may be received within a modified TS1 or TS2 training set.

Example 31 may include the apparatus of example 28 and/or some other example(s) herein, further comprising assigning the first logic stack as a primary link and the second logic stack as the secondary link.

Example 32 may include the apparatus of example 28 and/or some other example(s) herein, further comprising causing to renumber the subset of physical lanes by mapping physical lanes 8 through 15 as logical lanes 0 through 7 for the secondary link.

Example 33 may include the apparatus of example 28 and/or some other example(s) herein, further comprising setting a secondary link status bit in a configuration register based on the renumbering.

Example 34 may include the apparatus of example 28 and/or some other example(s) herein, wherein the negotiated data rate may be 256 Gigatransfers per second (GT/s).

Example 35 may include the apparatus of example 28 and/or some other example(s) herein, further comprising maintaining a first set of configuration registers for the first logic stack and a second set of configuration registers for the second logic stack.

Example 36 may include the apparatus of example 28 and/or some other example(s) herein, wherein the first logic stack and the second logic stack connect to a single shared physical layer.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
negotiate a data rate with an upstream port during a configuration state of a link training and status state machine;
receive a capability bit from the upstream port indicating a requirement for bifurcation at the negotiated data rate;
activate a first logic stack and a second logic stack to serve the upstream port based on the capability bit; and
determine a subset of physical lanes to establish a secondary link managed by the second logic stack.

2. The device of claim 1, wherein the processing circuitry is further configured to receive the capability bit by identifying a reserved bit in a training set field.

3. The device of claim 1, wherein the capability bit is received within a modified TS1 or TS2 training set.

4. The device of claim 1, wherein the processing circuitry is further configured to assign the first logic stack as a primary link and the second logic stack as the secondary link.

5. The device of claim 1, wherein the processing circuitry is further configured to cause to renumber the subset of physical lanes by mapping physical lanes 8 through 15 as logical lanes 0 through 7 for the secondary link.

6. The device of claim 1, wherein the processing circuitry is further configured to renumber a subset of physical lanes and setting a secondary link status bit in a configuration register based on the renumbering.

7. The device of claim 1, wherein the negotiated data rate is 256 Gigatransfers per second (GT/s).

8. The device of claim 1, wherein the processing circuitry is further configured to cause a first set of configuration registers to be associated with the first logic stack and a second set of configuration registers to be associated with the second logic stack.

9. The device of claim 1, wherein the first logic stack and the second logic stack connect to a single shared physical layer.

10. A non-transitory computer-readable medium storing computer-executable instructions which when executed by one or more processors result in performing operations comprising:
negotiating a data rate with an upstream port during a configuration state of a link training and status state machine;
receiving a capability bit from the upstream port indicating a requirement for bifurcation at the negotiated data rate;
activating a first logic stack and a second logic stack to serve the upstream port based on the capability bit; and
determining a subset of physical lanes to establish a secondary link managed by the second logic stack.

11. The non-transitory computer-readable medium of claim 10, wherein the operations further comprise receiving the capability bit by identifying a reserved bit in a training set field.

12. The non-transitory computer-readable medium of claim 10, wherein the capability bit is received within a modified TS1 or TS2 training set.

13. The non-transitory computer-readable medium of claim 10, wherein the operations further comprise assigning the first logic stack as a primary link and the second logic stack as the secondary link.

14. The non-transitory computer-readable medium of claim 10, wherein the operations further comprise causing to renumber the subset of physical lanes by mapping physical lanes 8 through 15 as logical lanes 0 through 7 for the secondary link.

15. The non-transitory computer-readable medium of claim 10, wherein the operations further comprise renumbering a subset of physical lanes and setting a secondary link status bit in a configuration register based on the renumbering.

16. The non-transitory computer-readable medium of claim 10, wherein the negotiated data rate is 256 Gigatransfers per second (GT/s).

17. The non-transitory computer-readable medium of claim 10, wherein the operations further comprise causing a first set of configuration registers to be associated with the first logic stack and a second set of configuration registers to be associated with the second logic stack.

18. The non-transitory computer-readable medium of claim 10, wherein the first logic stack and the second logic stack connect to a single shared physical layer.

19. A method comprising:
negotiating a data rate with an upstream port during a configuration state of a link training and status state machine;
receiving a capability bit from the upstream port indicating a requirement for bifurcation at the negotiated data rate;
activating a first logic stack and a second logic stack to serve the upstream port based on the capability bit; and
determining a subset of physical lanes to establish a secondary link managed by the second logic stack.

20. The method of claim 19, further comprising receiving the capability bit by identifying a reserved bit in a training set field.
